(19) United States
(12) Patent Application Publication
(10) Pub. No.: US 2014/0327749 A1
(43) Pub. Date: Nov. 6, 2014

(54) IMAGE PROCESSING DEVICE, STEREOSCOPIC IMAGE DISPLAY DEVICE, AND IMAGE PROCESSING METHOD

(71) Applicant: KABUSHIKI KAISHA TOSHIBA, Tokyo (JP)

(72) Inventors: Daisuke HIRAKAWA, Saitama-shi (JP); Yoshiyuki Kokojima, Yokohama-shi (JP)

(21) Appl. No.: 14/335,432

(22) Filed: Jul. 18, 2014

Related U.S. Application Data
(63) Continuation of application No. PCT/JP2012/051124, filed on Jan. 19, 2012.

(51) Int. Cl. H04N 13/04

(52) U.S. Cl. CPC H04N 13/0495; H04N 13/0402
USPC 348/54

(57) ABSTRACT

According to an embodiment, an image processing device includes an obtainer, a determiner, a controller, and a generator. The obtainer obtains a position of an object to be observed in volume data of a medical image. The determiner determines a region of interest by using the position of the object and an instructed region inputted by a user in the volume data so that the region of interest includes at least part of the object. The controller controls a relation between the region of interest and a display range that indicates a range allowed to be displayed stereoscopically on a display. The generator generates a stereoscopic image of the volume data according to the relation between the region of interest and the display range.

### CROSS-REFERENCE TO RELATED APPLICATIONS

This application is a continuation of PCT international application Ser. No. PCT/JP2012/051124 filed on Jan. 19, 2012 which designates the United States, the entire contents of which are incorporated herein by reference.

### FIELD

Embodiments described herein relate generally to an image processing device, a stereoscopic image display device, and an image processing method.

### BACKGROUND

In recent years, glasses-free 3D displays in which a light beam control element such as a lenticular lens is used to enable stereoscopic viewing of multiple view images, which are captured from a plurality of camera viewpoints, with the unaided eye have been put to practical use. In such a glasses-free 3D display, by adjusting a plurality of camera intervals or a plurality of camera angles, it is possible to change the pop out amount of stereoscopic images. Moreover, in a glasses-free 3D display, images displayed on the display surface, which represents a surface that neither pops out toward the near side nor recedes toward the far side during the stereoscopic viewing, can be displayed in the highest definition. Hence, according to an increase or a decrease in the pop out amount, there occurs a decline in the definition. Furthermore, the range within which high-definition stereoscopic display is possible is only a limited range. Hence, in case a pop out amount equal to or greater than a certain value is set, then it results in the formation of double images or blurred images.

Meanwhile, as far as medical diagnostic imaging devices such as X-ray computer tomography (CT) devices, magnetic resonance imaging (MRI) devices, or ultrasound diagnostic devices are concerned; some devices capable of generating three-dimensional medical images (hereinafter, called “volume data”) have been put to practical use. From the volume data generated by a medical diagnostic imaging device, it is possible to generate a volume rendering image (a parallax image) at an arbitrary parallax angle and with an arbitrary number of parallaxes. In that regard, it is being studied whether a two-dimensional volume rendering image, which is generated from the volume data, can be stereoscopically displayed in a glasses-free 3D display.

However, in the conventional technology, the stereoscopic image of an region of interest, on which the user should focus in the volume data, cannot be visually recognized in a satisfactory manner.

### BRIEF DESCRIPTION OF THE DRAWINGS

FIG. 1 is a diagram illustrating an image display system according to an embodiment;

FIG. 2 is a diagram for explaining an example of volume data;

FIG. 3 is a diagram illustrating a stereoscopic image display device according to the embodiment;

FIG. 4 is a schematic diagram illustrating a display according to the embodiment;

FIG. 5 is a schematic diagram illustrating the display according to the embodiment;

FIG. 6 is a conceptual diagram illustrating a case in which the volume data according to the embodiment is displayed in a stereoscopic manner;

FIG. 7 is a diagram illustrating an image processor according to the embodiment;

FIG. 8 is a front view of the display according to the embodiment;

FIG. 9 is a side view of the display according to the embodiment;

FIG. 10 is a diagram for explaining an example of a method for specifying an instructed region;

FIG. 11 is a diagram for explaining an example of the method for specifying the instructed region;

FIG. 12 is a diagram for explaining an example of the method for specifying the instructed region;

FIG. 13 is a diagram for explaining an example of the method for specifying the instructed region;

FIG. 14 is a diagram for explaining an example of a method for determining a region of interest;

FIG. 15 is a diagram for explaining an example of the method for determining the region of interest;

FIG. 16 is a diagram for explaining an example of the method for determining the region of interest;

FIG. 17 is a diagram for explaining an example of the method for determining the region of interest;

FIG. 18 is a diagram for explaining an example of performing depth control;

FIG. 19 is a diagram for explaining an example of performing depth control;

FIG. 20 is a diagram for explaining an example of performing position control;

FIG. 21 is a diagram for explaining an example of a method for generating a stereoscopic image of volume data;

FIG. 22 is a flowchart for explaining an example of operations performed in the stereoscopic image display device according to the embodiment;

FIG. 23 is a diagram illustrating an image processor according to a modification example;

FIG. 24 is a diagram illustrating an example of slide bars displayed on a screen;

FIG. 25 is a diagram illustrating an example of a method for adjusting the range of the region of interest;

FIG. 26 is a diagram illustrating an example of setting the display position of the region of interest; and

FIG. 27 is a diagram illustrating an example of a hardware configuration of the image processor.

### DETAILED DESCRIPTION

According to an embodiment, an image processing device includes an obtainer, a determiner, a controller, and a generator. The obtainer obtains a position of an object to be observed in volume data of a medical image. The determiner determines a region of interest by using the position of the object and an instructed region inputted by a user in the volume data so that the region of interest includes at least part of the object. The controller controls a relation between the region of interest and a display range that indicates a range allowed to be displayed stereoscopically on a display. The generator generates a stereoscopic image of the volume data according to the relation between the region of interest and the display range.

An embodiment of an image processing device, a stereoscopic image display device, and an image processing method according to the invention is described below in detail with reference to the accompanying drawings.

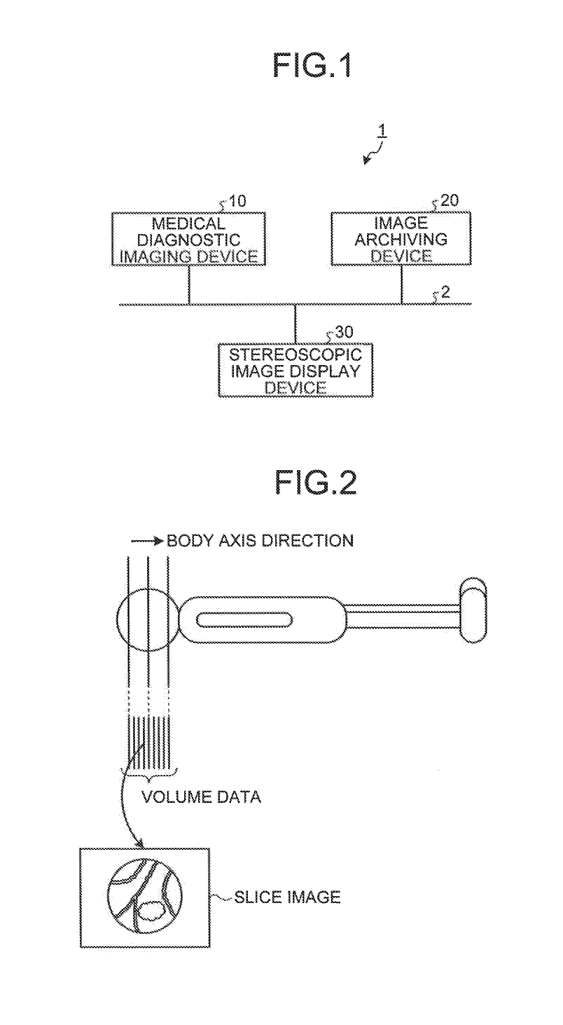

FIG. 1 is a block diagram illustrating an image display system 1 according to the embodiment. As illustrated in FIG. 1, the image display system 1 includes a medical diagnostic imaging device 10, an image archiving device 20, and a stereoscopic image display device 30. Each device illustrated in FIG. 1 can communicate with each other either directly or indirectly via a local area network (LAN) 2 that is installed in, for example, a hospital. Thus, each device is capable of sending medical images to and receiving medical images from the other devices.

The image display system 1 generates stereoscopic images from volume data, which is generated by the medical diagnostic imaging device 10. Then, the stereoscopic images are displayed in a display with the aim of providing stereoscopically-viewable medical images to the doctors or the laboratory personnel working in the hospital. Herein, a stereoscopic image includes a plurality of parallax images having mutually different parallaxes. Given below is the explanation of each device in turn.

The medical diagnostic imaging device 10 is capable of generating three-dimensional volume data related to medical images. Examples of the medical diagnostic imaging device 10 include an X-ray CT device, an MRI device, an ultrasound diagnostic device, a single photon emission computer tomography (SPECT) device, a positron emission computed tomography (PET) device, a SPECT-CT device configured by integrating a SPECT device and an X-ray CT device, a PET-CT device configured by integrating a PET device and an X-ray CT device, and a group of these devices.

The medical diagnostic imaging device 10 captures images of a subject being tested, and generates volume data. For example, the medical diagnostic imaging device 10 captures images of a subject being tested; collects data such as projection data or MR signals; reconfigures a plurality of (for example, 300 to 500) slice images (cross-sectional images) along the body axis direction of the subject being tested; and generates volume data. Thus, as illustrated in FIG. 2, a plurality of slice images, which is taken along the body axis direction of the subject being tested, represents the volume data. In the example illustrated in FIG. 2, the volume data of the brain of the subject being tested is generated. Meanwhile, the projection data or the MR signals of the subject being tested, which is captured by the medical diagnostic imaging device 10, can itself be considered as the volume data.

The volume data generated by the medical diagnostic imaging device 10 contains images of target objects for observation at the medical site (hereinafter, called “objects”) such as bones, blood vessels, nerves, tumors, and the like. According to the embodiment, the medical diagnostic imaging device 10 analyzes the generated volume data, and generates specifying information that enables identification of the position of each object in the volume data. The specifying information can contain arbitrary details. For example, as the specifying information, it is possible to use groups of information in each of which identification information enabling identification of an object is held in a corresponding manner to a group of voxels included in the object. Alternatively, as the specifying information, it is possible to use groups of information obtained by appending, to each voxel included in the volume data, identification information that enables identification of the object to which that voxel belongs. Besides, the medical diagnostic imaging device 10 can analyze the generated volume data and identify the position of the center of gravity of each object. Herein, the information indicating the position of the center of gravity of each object can also be included in the specifying information. Meanwhile, the user can refer to the specifying information that is automatically created by the medical diagnostic imaging device 10, and can correct the details of the specifying information. That is, the specifying information can be generated in a semi-automatic manner. Then, the medical diagnostic imaging device 10 sends the generated volume data and the specifying information to the image archiving device 20.

The image archiving device 20 represents a database for archiving the medical images. More particularly, the image archiving device 20 is used to store and archive the volume data and the specifying information sent by the medical diagnostic imaging device 10.

The stereoscopic image display device 30 is capable of displaying a plurality of parallax images having mutually different parallaxes, and thus enabling a viewer to view a stereoscopic image. The stereoscopic image display device 30 can be configured to implement, for example, the integral imaging method (II method) or the 3D display method in the multi-eye mode. Examples of the stereoscopic image display device 30 include a television (TV) or a personal computer (PC) that enables viewers to view stereoscopic images with the unaided eye. In the embodiment, the stereoscopic image display device 30 performs volume rendering with respect to the volume data that is obtained from the image archiving device 20, and generates and displays a group of parallax images. Herein, the group of parallax images is a group of images generated by performing a volume rendering operation in which the viewpoint position is shifted in increments of a predetermined parallax angle with respect to the volume data. Thus, the group of parallax images includes a plurality of parallax images having different viewpoint positions.

In the embodiment, while the user confirms the stereoscopic image of a medical image displayed on the stereoscopic image display device 30, the user is enabled to perform operations so as to satisfactorily display an area (a region of interest) on which the user desires to focus.

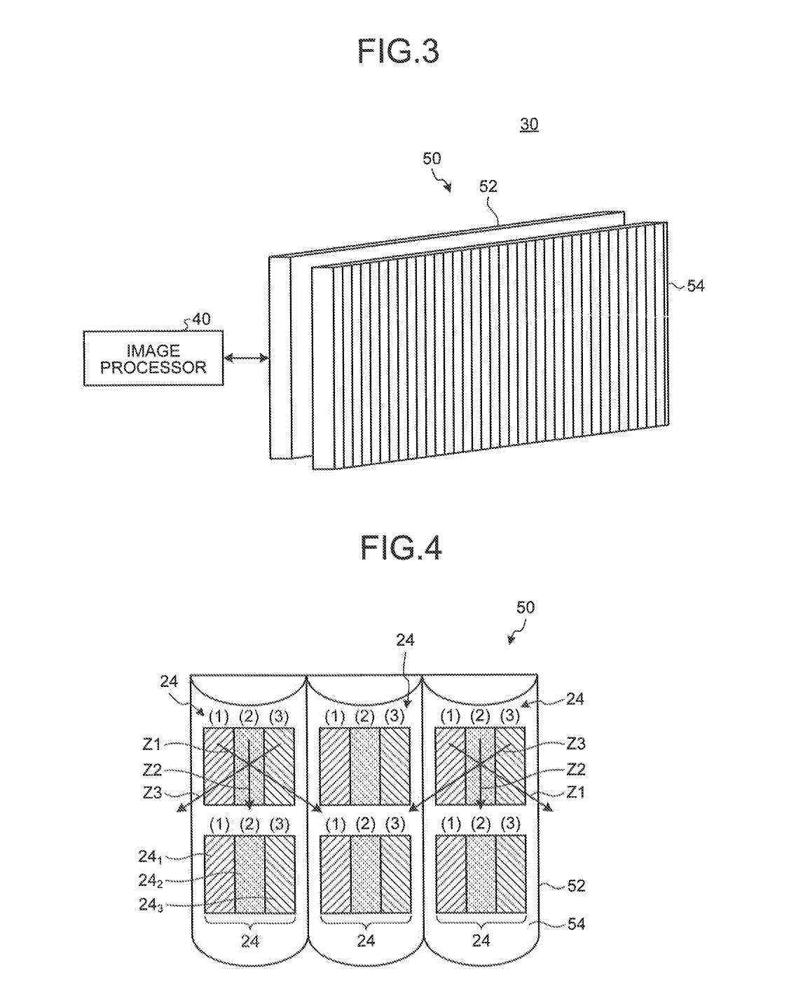

FIG. 3 is a diagram illustrating the stereoscopic image display device 30. As illustrated in FIG. 30, the stereoscopic image display device 30 includes an image processor 40 and a display 50. The image processor 40 performs image processing with respect to the volume data that is obtained from the image archiving device 20. The details of the image processing are given later.

The display 50 displays a stereoscopic image that is generated by the image processor 40. As illustrated in FIG. 3, the display 50 includes a display panel 52 and a light beam controller 54. The display panel 52 is a liquid crystal panel in which a plurality of sub-pixels having different color components (such as red (R), green (G), and blue (B) colors) are arranged in a matrix-like manner in a first-direction (for example, the row direction (the left-right direction) with reference to FIG. 3) and a second direction (for example, the column direction (the vertical direction) with reference to FIG. 3). In this case, a single pixel is made of RGB sub-pixels arranged in the first direction. Moreover, an image that is displayed on a group of pixels, which are adjacent pixels equal in number to the number of parallaxes and which are arranged in the first direction, is called an element image. Thus, the display 50 displays a stereoscopic image in which a plurality of element images is arranged in a matrix-like manner. Meanwhile, any other known arrangement of sub-pixels can be adopted in the display 50. Moreover, the sub-pixels are not limited to the three colors of red (R), green (G), and blue (B). Alternatively, for example, the sub-pixels can also have four colors.

As the display panel 52, it is possible to use a direct-view-type two-dimensional display such as an organic electro luminescence (organic EL), a liquid crystal display (LCD), a plasma display panel (PDP), or a projection-type display. Moreover, the display panel 52 can also have a backlight.

The light beam controller 54 is disposed opposite to the display panel 52 with a clearance gap maintained therebetween. The light beam controller 54 controls the direction of emission of the light beam that is emitted from each sub-pixel of the display panel 52. The light beam controller 54 has a plurality of linearly-extending optical apertures arranged in the first direction for shooting out the light beams. For example, the light beam controller 54 can be a lenticular sheet having a plurality of cylindrical lenses arranged thereon or can be a parallax barrier having a plurality of slits arranged thereon. The optical apertures are arranged corresponding to the element images of the display panel 52.

In the embodiment, in the stereoscopic image display device 30, the sub-pixels of each color component are arranged in the second direction, while the color components are repeatedly arranged in the first direction thereby forming a “longitudinal stripe arrangement”. However, that is not the only possible case. Moreover, in the first embodiment, the light beam controller 54 is disposed in such a way that the extending direction of the optical apertures thereof is consistent with the second direction of the display panel 52. However, that is not the only possible case. Alternatively, the light beam controller 54 may be disposed in such a way that the extending direction of the optical apertures thereof has a predetermined tilt with respect to the second direction of the display panel 52.

FIG. 4 is a schematic diagram illustrating some portion of the display 50 in an enlarged manner. In FIG. 4, identification information of parallax images is represented as parallax numbers (1) to (3). Thus, herein, parallax numbers that are uniquely assigned to parallax images represent the identification information of the parallax images. Hence, the pixels corresponding to the same parallax number display the same parallax image. In the example illustrated in FIG. 4, an element image 24 is created by arranging the pixels of each of the parallax images that are identified by the parallax numbers (1) to (3) in that sequence. Herein, although the explanation is given for an example in which there are three parallaxes (corresponding to parallax numbers 1 to 3), it is not the only possible case. Alternatively, any other number of parallaxes (for example, nine parallaxes corresponding to parallax numbers 1 to 9) can be used.

As illustrated in FIG. 4, in the display panel 52, the element images 24 are arranged in a matrix-like manner in the first direction and the second direction. For example, when the number of parallaxes is equal to three, each element image 24 is a group of pixels in which a pixel 24₁of a parallax image 1, a pixel 24₂ of a parallax image 2, and a pixel 24₃ of a parallax image 3 are sequentially arranged in the first direction.

In each element image 24, the light beams emitted from the pixels (the pixel 24₁ to the pixel 24₃) of the parallax images reach the light beam controller 54. Then, the light beam controller 54 controls the travelling direction and the scattering of each light beam, and shoots the light beams toward the whole surface of the display 50. For example, in each element image 24, the light emitted from the pixel 24₁ of the parallax image 1 travels in the direction of an arrow Z1; the light emitted from the pixel 24₂ of the parallax image 2 travels in the direction of an arrow Z2; and the light emitted from the pixel 24₃ of the parallax image 3 travels in the direction of an arrow Z3. In this way, in the display 50, the direction of emission of the light emitted from each pixel in each element image is regulated by the light beam controller 54.

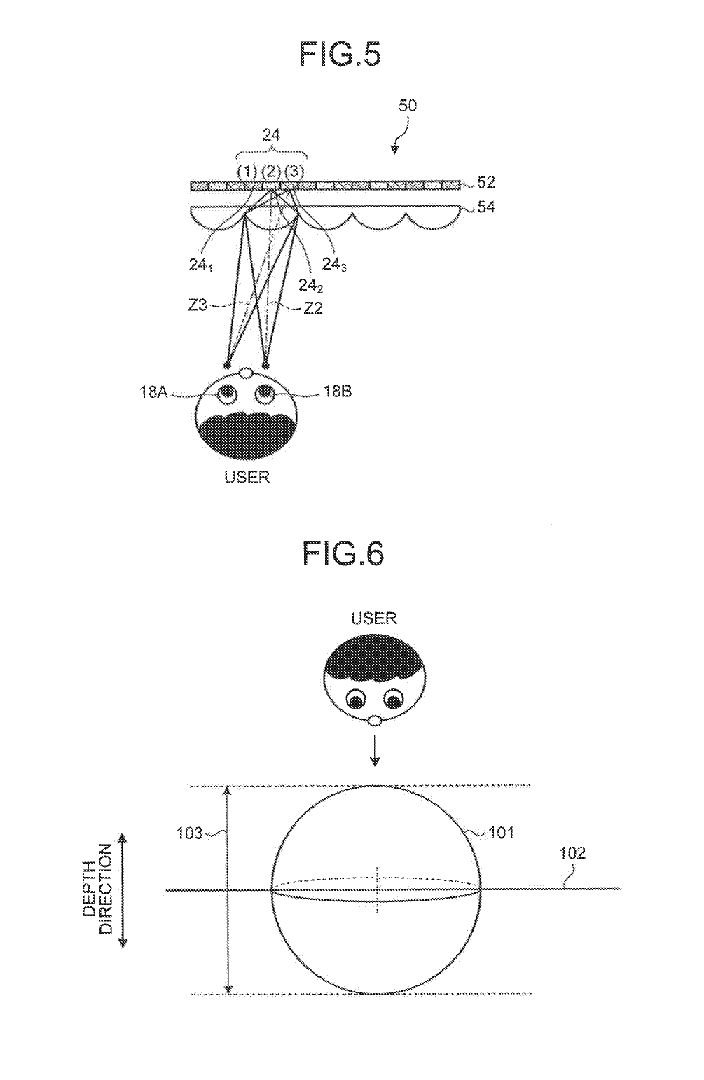

FIG. 5 is a schematic diagram illustrating a situation in which a user (viewer) is viewing the display 50. When a stereoscopic image made of a plurality of element images 24 is displayed on the display panel 52, the pixels of the parallax images included in the element images 24 and viewed by the user with a left eye 18A are different than the pixels of the parallax images included in the element images 24 and viewed by the user with a right eye 18B. In this way, when images having different parallaxes are displayed with respect to the left eye 18A and the right eye 18B of the user, it becomes possible for the user to view stereoscopic images.

FIG. 6 is a conceptual diagram illustrating a case in which the volume data of the brain illustrated in FIG. 2 is displayed in a stereoscopic manner. In FIG. 6, a stereoscopic image 101 represents a stereoscopic image of the volume data of the brain. Moreover, in FIG. 6, a display surface 102 represents the display surface of the display 50. The display surface represents such a surface that, during stereoscopic viewing, neither pops out toward the near side nor recedes toward the far side. Longer the distance from the display surface 102, sparser becomes the density of light beams emitted from the pixels of the display panel 52. Hence, the resolution of images also goes on deteriorating. In that regard, with the aim of displaying the entire volume data of the brain in high-definition, it is necessary to take into account a stereoscopic display allowable range 103 that indicates the range in the depth direction within which the display 50 including the display surface can display stereoscopic images (i.e., indicates a display limit). That is, as illustrated in FIG. 6, various parameters (such as camera intervals, camera angles, and camera positions at the time of creating stereoscopic images) need to be set in such a way that, during the stereoscopic display, the entire volume data 101 of the brain is within the stereoscopic display allowable range 103. Herein, the stereoscopic display allowable range 103 is a parameter determined depending on the specifications or the standards of the display 50, and can be stored in a memory (not illustrated) that is installed in the stereoscopic image display device 30 or can be stored in an external device.

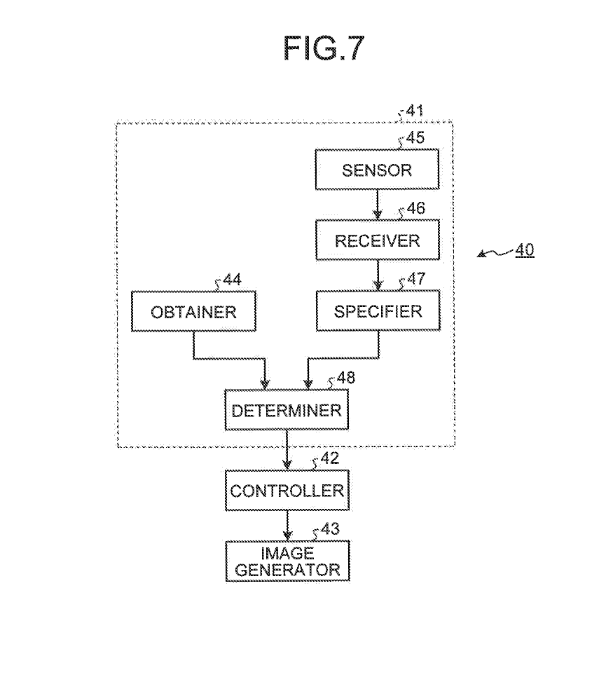

Given below is the detailed explanation of the image processor 40. FIG. 7 is a block diagram illustrating the image processor 40. As illustrated in FIG. 7, the image processor 40 includes a setter 41, a controller 42, and an image generator 43.

The setter 41 sets a region of interest, on which the user should focus, in the volume data (in this example, in the volume data of the brain illustrated in FIG. 2). In the embodiment, prior to the setting of the region of interest, the stereoscopic image of the volume data, which is obtained from the image archiving device 20, is displayed on the display 50 without being subjected to depth control (described later) and position control (described later). Herein, the stereoscopic image of the volume data that is displayed on the display 50 without being subjected to depth control and position control is called a “default stereoscopic image”. Thus, while confirming the default stereoscopic image, the user specifies (points) a predetermined position in the three-dimensional space of the display 50 using, for example, an input device such as a pen. According to that specification, the region of interest gets set. More particularly, the explanation is as given below.

As illustrated in FIG. 7, in the embodiment, the setter 41 includes an obtainer 44, a sensor 45, a receiver 46, a specifier 47, and a determiner 48. In the embodiment, the obtainer 44 obtains a position of an object to be observed in volume data of a medical image. The obtainer 44 obtains the specifying information that enables identification of the positions of the objects included in the volume data. More particularly, the obtainer 44 accesses the image archiving device 20 and obtains the specifying information stored in the image archiving device 20.

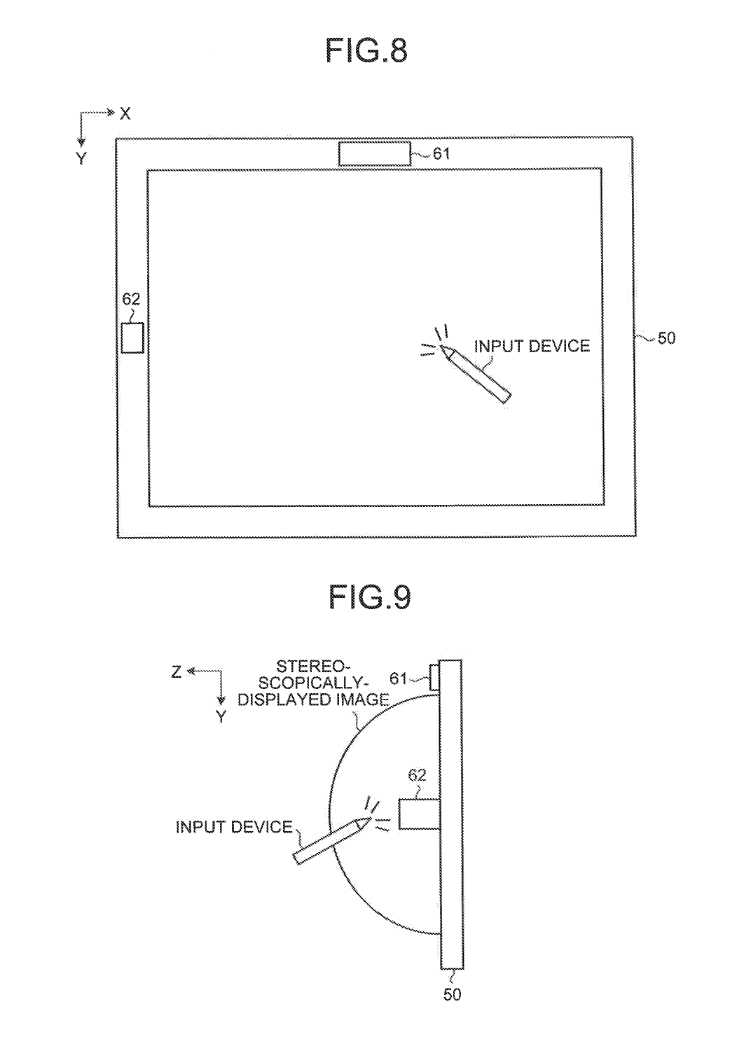

The sensor 45 detects the coordinate value of the input device (such as a pen) in the three-dimensional space of the display 50 in which the stereoscopic image is displayed. The input device corresponds to an indicator that is used by the user 4 to indicate a three-dimensional position. FIG. 8 is a front view of the display 50, while FIG. 9 is a side view of the display 50. As illustrated in FIGS. 8 and 9, the sensor 45 includes a first detector 61 and a second detector 62. Moreover, in the embodiment, the input device used by the user for inputting purposes is configured with a pen that emits sound waves and infrared light from the leading end portion thereof. The first detector 61 detects the position of the input device in the X-Y plane illustrated in FIG. 8. More particularly, the first detector 61 detects the sound waves and the infrared light emitted from the input device, and calculates the coordinate value of the input device in the X-direction and the coordinate value of the input device in the Y-direction based on the period of time taken by the sound waves to reach the first detector 61 and the period of time taken by the infrared light to reach the first detector 61. The second detector 62 detects the position of the input device in the Z-direction illustrated in FIG. 9. In an identical manner to the first detector 61, the second detector 62 detects the sound waves and the infrared light emitted from the input device, and calculates the coordinate value of the input device in the Z-direction based on the period of time taken by the sound waves to reach the second detector 62 and the period of time taken by the infrared light to reach the second detector 62. However, that is not the only possible case. Alternatively, for example, the input device can be configured with a pen that emits either only sound waves or only infrared light from the leading end portion thereof. In that case, the first detector 61 can detect the sound waves (or the infrared light) emitted from the input device, and can calculate the coordinate value of the input device in the X-direction and the coordinate value of the input device in the Y-direction based on the period of time taken by the sound waves (or the infrared light) to reach the first detector 61. In an identical manner, the second detector 62 can detect the sound waves (or the infrared light) emitted from the input device, and can calculate the coordinate value of the input device in the Z-direction (the depth direction) based on the period of time taken by the sound waves (or the infrared light) to reach the second detector 62. In this example, the pen (indicator) and the sensor 45 can be considered as an input apparatus in claims.

Meanwhile, the sensor 45 is not limited to the explanation given above. That is, in essence, as long as the sensor 45 is able to detect the coordinate value of the input device in the three-dimensional space of the display 50, it serves the purpose. Besides, the type of the input device is also not limited to a pen. Alternatively, for example, a finger of the viewer can serve as the input device, or a surgical knife or a scissor can serve as the input device. In the embodiment, when the user confirms the default stereoscopic image and specifies a predetermined position in the three-dimensional space of the display 50 using the input device; the sensor 45 detects the three-dimensional coordinate value of the input device at that point of time.

The receiver 46 receives input of the three-dimensional coordinate value detected by the sensor 45 (that is, receives an input from the user). In response to the input from the user, the specifier 47 specifies an area in the volume data (hereinafter, called an “instructed region”). Herein, the instructed region can be a point present in the volume data or can be a surface having a certain amount of spread.

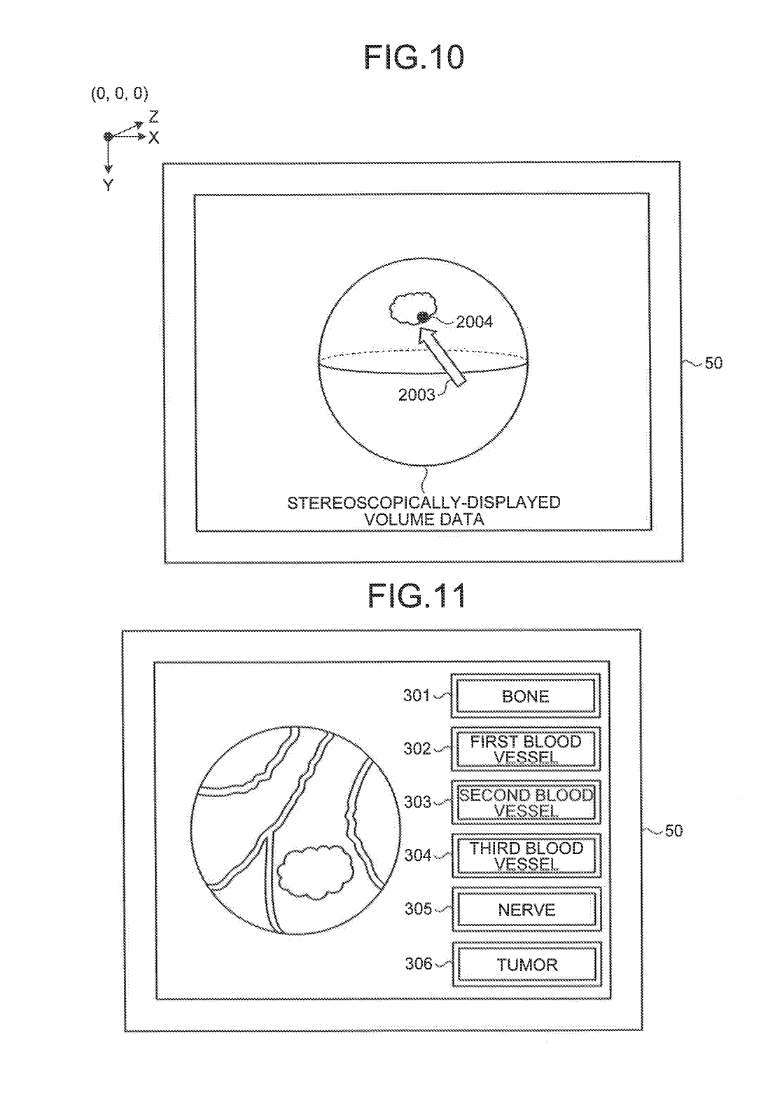

In the embodiment, the specifier 47 specifies, as the instructed region, a normalized value that is obtained by normalizing the three-dimensional coordinate value, which is detected by the sensor 45, in a corresponding manner to the coordinates in the volume data. For example, assume that the range of coordinates in the volume data is 0 to 512 in the X-direction, 0 to 512 in the Y-direction, and 0 to 256 in the Z-direction. Moreover, assume that the detectable range in the three-dimensional space of the display 50 that is detectable by the sensor 45 (i.e., the range of spatial coordinates in a stereoscopically-displayed medical image) is 0 to 1200 in the X-direction, 0 to 1200 in the Y-direction, and 0 to 1200 in the Z-direction. If (x1, y1, z1) represents the three-dimensional coordinate value detected by the sensor 45, then the instructed region is equal to (x1×(512/1200), y1×(512/1200), z1×(256/1200)). Meanwhile, the stereoscopically-displayed medical image and the leading end of the input device need not appear to be coincident to each other. As illustrated in FIG. 10, a three-dimensional coordinate value 2004 can be normalized by shifting the y-coordinate thereof toward the direction of 0 with reference to the leading end of an input device 2003. Alternatively, the three-dimensional coordinate value 2004 can be normalized by shifting the z-coordinate thereof toward the direction of the display surface with reference to the leading end of the input device 2003. Meanwhile, the instructed region specified by the specifier 47 is not limited to a single instructed region. That is, a plurality of instructed regions may also be specified.

Moreover, the method of specifying the instructed region is not limited to the method explained above. Alternatively, for example, as illustrated in FIG. 11, an icon corresponding to each object such as a bone, a blood vessel, a nerve, and a tumor can be displayed on the screen of the display 50. Then, the user can select a displayed icon using a mouse or by performing a touch operation. In the example illustrated in FIG. 11, on the screen of the display 50 are displayed an icon 301 corresponding to a bone, an icon 302 corresponding to a first blood vessel, an icon 303 corresponding to a second blood vessel, an icon 304 corresponding to a third blood vessel, an icon 305 corresponding to a nerve, and an icon 306 corresponding to a tumor. Then, the specifier 47 specifies, as the instructed region, the object corresponding to the user-selected icon. Herein, the user can select either a single icon or a plurality of icons. Thus, the specifier 47 can specify a plurality of objects. Meanwhile, for example, the configuration can be such that the default stereoscopic image is not displayed, and only a plurality of selectable icons is displayed on the screen of the display 50 or on the screen of an operation monitor other than the display 50.

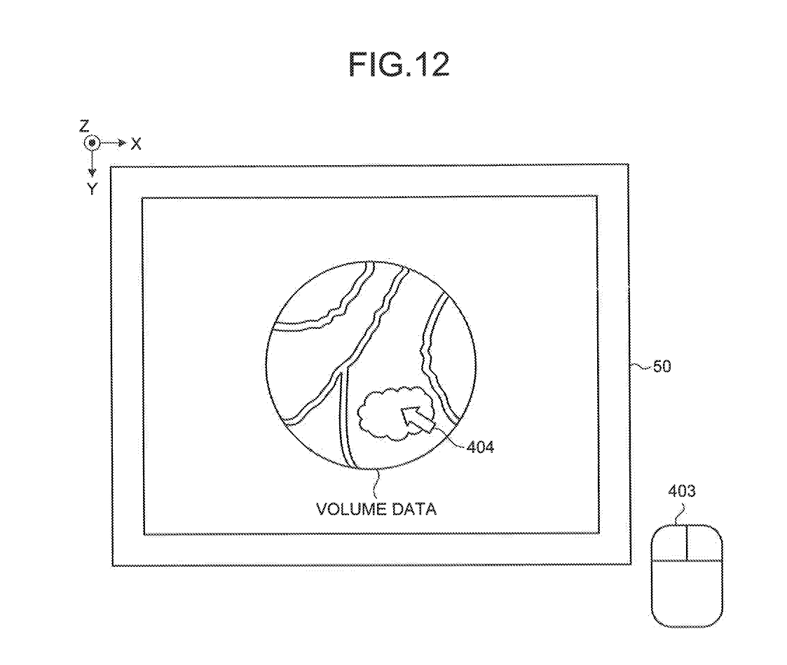

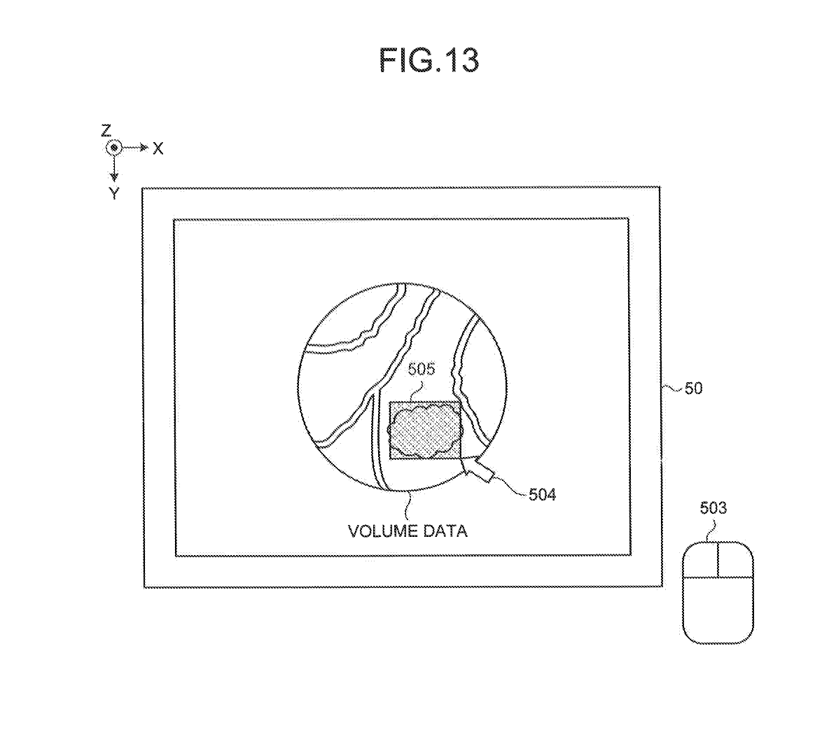

Meanwhile, for example, the user can operate a keyboard and directly input a three-dimensional coordinate value within the volume data. Alternatively, for example, as illustrated in FIG. 12, the user can operate a mouse 403 and specify a two-dimensional coordinate value (x, y) within the volume data using a mouse cursor 404 so that, depending on the value of the mouse wheel or depending on the period of time of continuing clicking, a coordinate value z in the Z-direction is input. Still alternatively, for example, as illustrated in FIG. 13, the user can operate a mouse 503 and specify an X-Y plane 505 in a portion of the volume data using a mouse cursor 504 so that, depending on the value of the mouse wheel or depending on the period of time of continuing clicking, the coordinate value z in the Z-direction is input. Still alternatively, the user can perform a touch operation and specify a two-dimensional coordinate value (x, y) within the volume data so that, depending on the period of time of continuing touching, the coordinate value z in the Z-direction is input. Still alternatively, the configuration can be such that, when the user touches the screen of the display 50, a slide bar is displayed that has a variable amount of sliding according to the user operation. Then, depending on the amount of sliding, the coordinate value z in the Z-direction is input. The specifier 47 can specify, as the instructed region, the input point or the input plane within the volume data.

Returning to the explanation with reference to FIG. 7, the determiner 48 determines a region of interest by using the position of the object and an instructed region inputted by a user in the volume data so that the region of interest includes at least part of the object. Specifically, the determiner 48 determines the region of interest by using the specifying information obtained by the obtainer 44 and the instructed region specified by the specifier 47. In the embodiment, the determiner 48 obtains the position of the center of gravity of each object that is included in the specifying information obtained by the obtainer 44; obtains the distance from each object to the three-dimensional coordinate value specified by the specifier 47; and determines the object having the smallest distance to be the region of interest. More particularly, the explanation is as given below. Herein, it is assumed that (x1, y1, z1) represents the three-dimensional coordinate value (the instructed region) specified by the specifier 47. Moreover, it is assumed that the specifying information obtained by the obtainer 44 contains the positions of the center of gravity of three objects (called a first object, a second object, and a third object); and it is assumed that (x2, y2, z2) represents the coordinate value of the position of the center of gravity of the first object, (x3, y3, z3) represents the coordinate value of the position of the center of gravity of the second object, and (x4, y4, z4) represents the coordinate value of the position of the center of gravity of the third object. Meanwhile, if the specifying information does not contain the information indicating the position of the center of gravity of each object, then it is assumed that the determiner 48 calculates the information (the coordinate value) indicating the position of the center of gravity of each object based on the specifying information.

Herein, if d2 represents the distance between the three-dimensional coordinate value (x1, y1, z1), which is specified by the specifier 47, and the coordinate value (x2, y2, z2), which indicates the position of the center of gravity of the first object; then d2 can be obtained using Equation 1 given below.

d2=\sqrt{(x1−x2)²+(y1−y2)²+(z1−z2)²} (1)

Similarly, if d3 represents the distance between the three-dimensional coordinate value (x1, y1, z1), which is specified by the specifier 47, and the coordinate value (x3, y3, z3), which indicates the position of the center of gravity of the second object; then d3 can be obtained using Equation 2 given below.

d3={square root over (x1−x3)²+(y1−y3)²+(z1−z3)²)} (2)

Moreover, if d4 represents the distance between the three-dimensional coordinate value (x1, y1, z1), which is specified by the specifier 47, and the coordinate value (x4, y4, z4), which indicates the position of the center of gravity of the third object; then d4 can be obtained using Equation 3 given below.

d4=\sqrt{(x1−x4)²+(y1−y4)²+(z1−z4)²} (3)

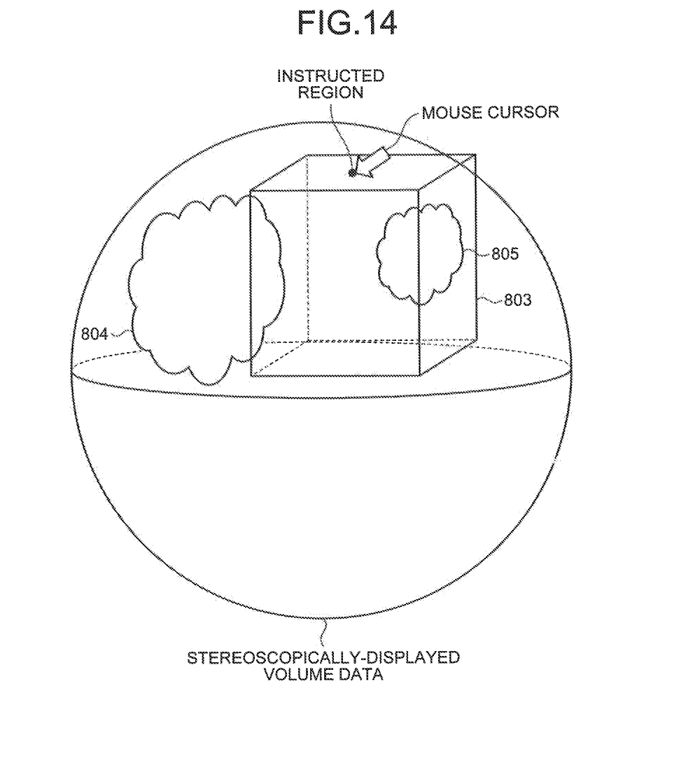

Then, the determiner 48 determines that the object having the smallest value of the calculated distance is the region of interest. However, the method of determining the region of interest is not limited to this method. Alternatively, for example, the object having the smallest distance in the X-Y plane with the exclusion of the Z-direction (the depth direction) can be determined to be the region of interest. Still alternatively, for each voxel coordinate included in each object, the distance to the instructed region can be calculated and the object that includes the voxel coordinate having the smallest distance can be determined to be the region of interest. Still alternatively, for example, as illustrated in FIG. 14, within a cuboid or spherical area 803 that has an arbitrary size with the instructed region serving as the base point, the object having the largest number of voxels (in the example illustrated in FIG. 14, an object 805) can be determined to be the region of interest.

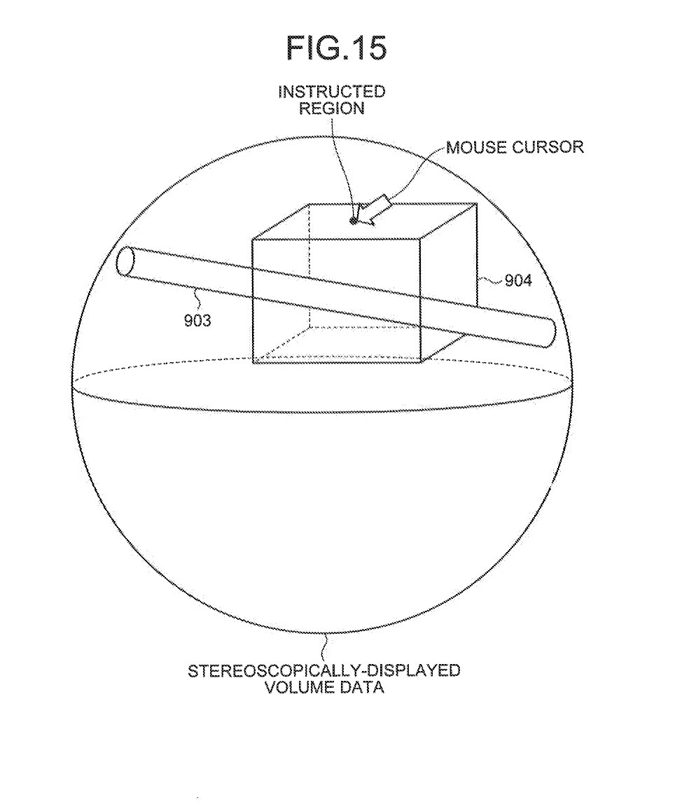

Still alternatively, instead of determining an object that is present in the volume data to be the region of interest, a cuboid or spherical area that has an arbitrary size with the instructed region serving as the base point can also be determined to be the region of interest. Still alternatively, if an object is present at a distance equal to or smaller than a predetermined threshold distance from the instructed region, then that object can be determined to be the region of interest. Still alternatively, if an object is present at a distance equal to or smaller than a predetermined threshold distance from the instructed region, then a cuboid or spherical area that has an arbitrary size with the instructed region serving as the base point can be determined to be the region of interest. Still alternatively, for example, as illustrated in FIG. 15, if an object 903 that is determined to be the region of interest has an elongated shape, a portion of the object 903 which is not present within a predetermined range 904 is excluded from the object 903 and a portion of the object 903 which is present within a predetermined range 904 can be determined to be the region of interest.

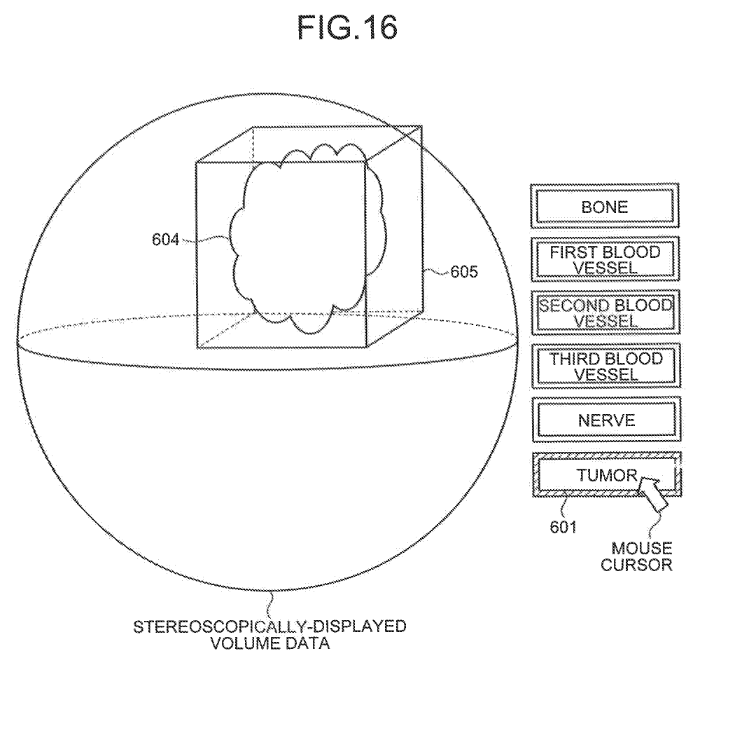

Meanwhile, as illustrated in FIG. 11, when the object corresponding to the selected icon is specified as the instructed region, the object that is specified as the instructed region can be determined to be the region of interest by the determiner 48. For example, if the specifying information obtained by the obtainer 44 represents information in which each voxel included in the volume data is associated to the identification information of the corresponding object; then the determiner 48 can select the identification information of the object specified as the instructed region and determine, as the region of interest, the group of voxels that are associated to the selected identification information. Alternatively, for example, as illustrated in FIG. 16, when an icon 601 is selected; the determiner 48 can determine, as the region of interest, a cuboid 605 in which an object 604 (in this example, a “tumor”) corresponding to the selected icon 601 fits in entirety. Still alternatively, if a plurality of icons is selected and a plurality of objects is specified as the instructed region, then the determiner 48 can set, as the region of interest, an area that includes the objects specified as the instructed region.

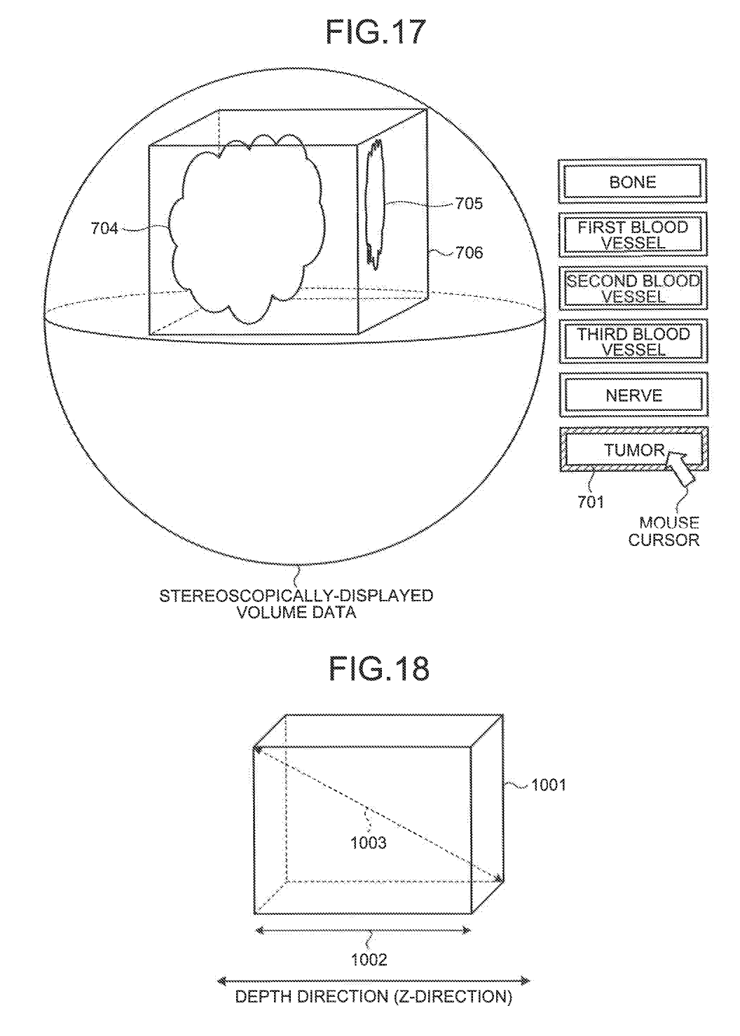

Meanwhile, if an object is present on the periphery of the instructed region specified by the specifier 47, then the determiner 48 can determine, as the region of interest, an expanded area that includes the instructed region and at least some portion of the object present on the periphery of the instructed region. For example, as illustrated in FIG. 17, when the user selects an icon 701 so that a corresponding object 704 is specified as the instructed region and when a different object 705 is present on the periphery of the object 704; the determiner 48 can determine, as the region of interest, an expanded area 706 that includes the object 704 and the object 705 present on the periphery of the object 704. Herein, the expanded area need not always include the entire object 705 present on the periphery of the instructed region (in the example illustrated in FIG. 17, the object 704), and may include only some portion of the object 705.

In essence, the determiner 48 can determine, as the region of interest, an expanded area that includes the instructed region and at least some portion of an object present on the periphery of the instructed region. For example, from among the objects included in the volume data, when the target object for operation (for example, a tumor) is specified as the instructed region, then an area including the target object for operation and other objects (for example, blood vessels or nerves) present on the periphery of the target object for operation is set as the region of interest. That makes it possible for the doctor to accurately understand the positional relationship between the target object for operation and the objects on the periphery thereof. As a result, an appropriate diagnosis can be made prior to performing the operation.

Given below is the explanation of the details of the controller 42 illustrated in FIG. 7. The controller 42 controls a relation between the region of interest and a display range (i.e., the stereoscopic display allowable range) that indicates a range allowed to be displayed stereoscopically on a display. For example, the controller 42 controls the relation between the region of interest and the display range so that the region of interest is included in the display range. More specifically, the controller 42 performs control to bring a depth of the region of interest closer to an upper limit of the display range. For example, the controller 42 controls the relation between the region of interest and the display range so that a display position of the region of interest is close to the display surface. More specifically, the controller 42 sets the display position of the region of interest on a near side as compared to the display surface. In the embodiment, based on position information of the region of interest, the controller 42 performs at least one of depth control and position control. Herein, the position information of the region of interest represents the information indicating the position of the region of interest in the volume data. For example, the position information of the region of interest can be obtained using the specifying information that is obtained by the obtainer 44. Firstly, the explanation is given about performing the depth control. In the case in which the default stereoscopic image is generated, the setting is done in such a way that the entire volume data fits within the stereoscopic display allowable range. For that reason, a depth range indicating the depth of the stereoscopically-displayed region of interest cannot be brought sufficiently closer to the stereoscopic display allowable range, thereby making it difficult to sufficiently express the stereoscopic effect of the region of interest. In that regard, in the embodiment, the controller 42 performs the depth control in which, as compared to the state before the setter 41 sets the region of interest, the depth range indicating the depth of the region of interest that is stereoscopically displayed on the display 50 is set to a value closer to the stereoscopic display allowable range. As a result, it becomes possible to abundantly express the stereoscopic effect of the region of interest. In the embodiment, the controller 42 performs the depth control in such a way that the depth range of the region of interest is fit within the stereoscopic display allowable range.

In the embodiment, the controller 42 sets the depth range in such a way that the width in the depth direction (the Z-direction) of the region of interest in the volume data is consistent with the width of the stereoscopic display allowable range. For example, as illustrated in FIG. 18, when a cuboid area 1001 of an arbitrary size in the volume data is set as the region of interest, the controller 42 performs the depth control in such a way that a width 1002 in the depth direction (the Z-direction) of the region of interest is consistent with the width of the stereoscopic display allowable range.

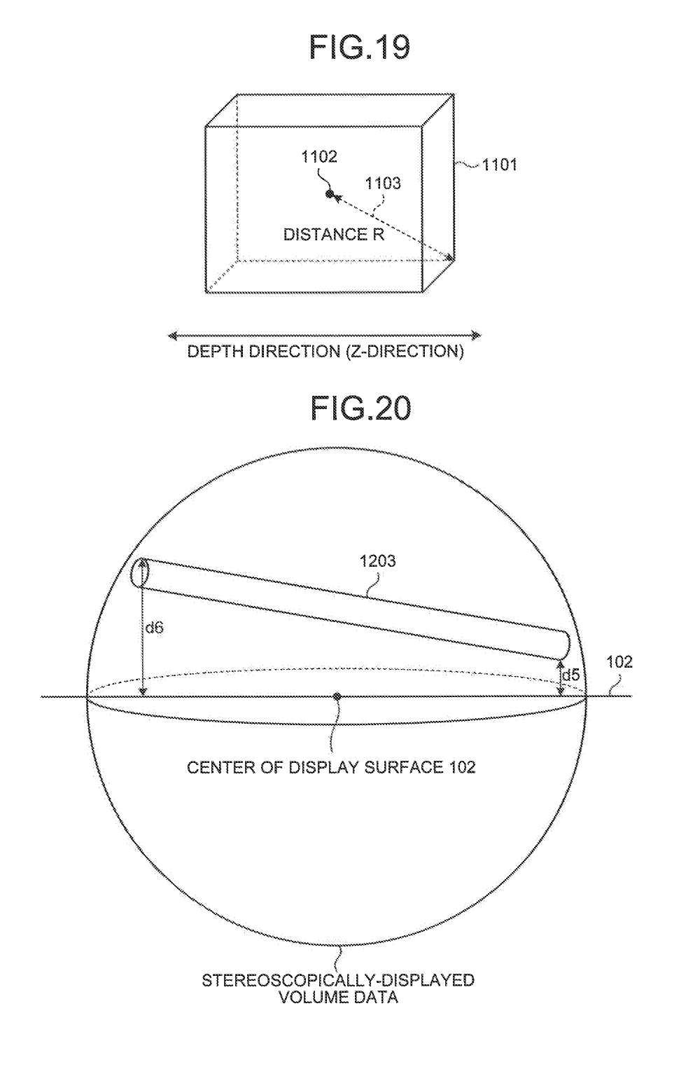

Meanwhile, if the region of interest 1001 is stereoscopically displayed in a rotatable manner, then the depth control can be performed in such a way that a maximum length 1003 of the region of interest 1001 is consistent with the width of the stereoscopic display allowable range. Thus, even when the region of interest 1001 is stereoscopically displayed in a rotatable manner, it becomes possible to fit the region of interest 1001 within the stereoscopic display allowable range. As a result, a high-definition stereoscopic display can be achieved while achieving abundant expression of the stereoscopic effect. Meanwhile, for example, as illustrated in FIG. 19, when a cuboid area 1101 of an arbitrary size in the volume data is set as the region of interest, the depth control can be performed in such a way that, using a distance R (1103) from a position 1102 of the center of gravity to the farthest point in the region of interest 1101, “2×R” is consistent with the width of the stereoscopic display allowable range. Herein, if cx represents the center of the greatest width in the X-direction of the region of interest, if cy represents the center of the greatest width in the Y-direction of the region of interest, and if cz represents the center of the greatest width in the Z-direction of the region of interest; then (cx, cy, cz) can be used in place of the center of gravity.

Meanwhile, it is also possible to perform the depth control in such a way that the ratio of the depth direction of the stereoscopically-displayed region of interest and a direction perpendicular to the depth direction (i.e., the X-direction or the Y-direction) is close to the ratio in the real world. More particularly, the controller 42 can set the depth range of the region of interest in such a way that the ratio of the X-direction, the Y-direction, and the Z-direction of the stereoscopically-displayed region of interest is close to the ratio in the real world. Moreover, for example, while the default stereoscopic image is being displayed, if the ratio of the X-direction, the Y-direction, and the Z-direction of the region of interest is close to the ratio of the object in the real world; then the controller 42 needs not perform the depth control. In this way, it becomes possible to prevent a situation in which the shape of the stereoscopically-displayed region of interest is different than the shape in the real world.

Given below is the explanation about performing the position control. Since the region of interest set by the setter 41 represents the area on which the user wishes to focus, it is preferable to display the region of interest in high-definition. In that regard, in the embodiment, the controller 42 performs the position control so as to set the display position of the region of interest, which is set by the setter 41, close to the display surface. As described earlier, since an image displayed on the display screen of the display 50 is displayed in the highest definition, bringing the display position of the region of interest close to the display surface makes it possible to display the region of interest in high-definition. In the embodiment, the controller 42 performs the position control in such a way that the stereoscopically-displayed region of interest fits within the stereoscopic display allowable range.

Herein, for example, the explanation is given under the assumption that the cuboid area 1001 illustrated in FIG. 18 is set as the region of interest. Herein, if cx represents the center of the greatest width in the X-direction of the region of interest 1001, if cy represents the center of the greatest width in the Y-direction of the region of interest 1001, and if cz represents the center of the greatest width in the Z-direction of the region of interest 1001; then, in the case of displaying the region of interest 1001 in a stereoscopic manner, the controller 42 sets the display position of the region of interest 1001 in such a way that (cx, cy, cz) matches with the center position of the display surface. Meanwhile, as long as the display position of the region of interest is set to be close to the display surface, the display position of the region of interest is not limited to be near the center of the display surface.

Meanwhile, the method for performing the position control is not limited to the example explained above. Alternatively, for example, the display position of the region of interest can be set in such a way that the position of the center of gravity of the region of interest matches with the center position of the display surface. Still alternatively, the display position of the region of interest can be set in such a way that the midpoint of the greatest length of the region of interest matches with the center position of the display surface. When at least a single object is present in the region of interest, the display position of the region of interest can be set in such a way that the position of the center of gravity of any one object matches with the center position of the display surface. However, for example, as illustrated in FIG. 20, when an region of interest 1203 has the shape of an elongated rod, it is not necessarily the best way to match a set of three-dimensional coordinates present in the region of interest 1203 to the center of the display surface. In such a case, the display position of the region of interest can be set in such a way that, instead of a set of three-dimensional coordinates present in the region of interest 1203, a set of three-dimensional coordinates present in the volume data matches with the center position of the display surface 102. In the example illustrated in FIG. 20, in a default state, d5 represents the smallest value of the distance in the depth direction from the region of interest 1203 to the display surface 102, and d6 represents the greatest value of the distance in the depth direction from the region of interest 1203 to the display surface 102. In this example, the controller 42 can set the display position of the region of interest 1203 in such a way that the stereoscopic image of the region of interest 1203 is shifted in the depth direction toward the display surface from the default state by a distance equal to (d5+d6)/2.

By performing the depth control and the position control as described above, the controller 42 sets various parameters such as camera intervals, camera angles, and camera positions at the time of creating stereoscopic images; and sends the set parameters to the image generator 43. Meanwhile, in the embodiment, although the controller 42 performs the depth control as well as the position control, it is not the only possible case. Alternatively, the controller 42 can be configured to perform only one of the depth control and the position control. In essence, as long as the controller 42 performs at least one of the depth control or the position control, it serves the purpose.

Explained below are the details of the image generator 43 illustrated in FIG. 7. The generator 43 generates a stereoscopic image of the volume data according to the relation between the region of interest and the display range. The generator generates the stereoscopic image of which a pixel on the display surface neither pops out nor recedes. According to the result of the control performed by the controller 42, the image generator 43 generates a stereoscopic image of the volume data. More particularly, the image generator 43 obtains the volume data and the specifying information from the image archiving device 20; performs a volume rendering operation according to the various parameters set by the controller 42; and generates a stereoscopic image of the volume data. Herein, while creating a stereoscopic image of the volume data, it is possible to implement various known volume rendering technologies.

The generator 43 generates the stereoscopic image of the volume data in such a way that, of the volume data, a region which overlaps with the region of interest is hidden. For example, the image generator 43 can generate a stereoscopic image of the volume data in such a way that, of the volume data, the image portion other than the region of interest is hidden. That is, regarding the image portion other than the region of interest in the volume data, the image generator 43 can set the pixel values to a value representing hiding. Alternatively, the configuration can be such that the image portion other than the region of interest is not generated in the first place. Still alternatively, the image generator 43 can generate a stereoscopic image of the volume data in such a way that the image portion other than the region of interest is closer to being transparent than the region of interest. That is, regarding the image portion other than the region of interest in the volume data, the image generator 43 can set the pixel values to a value closer to transparency than the region of interest.

Still alternatively, the generator can generate the stereoscopic image of the volume data in such a way that, of the volume data, a region which does not overlap with the region of interest and which is positioned on the outside of the display range is translucent. Still alternatively, the image generator 43 can generate a stereoscopic image of the volume data in such a way that, during the stereoscopic display, such an image portion of the volume data which is on the outside of the stereoscopic display allowable range is hidden. Alternatively, the image generator 43 can generate a stereoscopic image of the volume data in such a way that, during the stereoscopic display, such an image portion of the volume data which is on the outside of the stereoscopic display allowable range is closer to being transparent than the image portion present in the stereoscopic display allowable range.

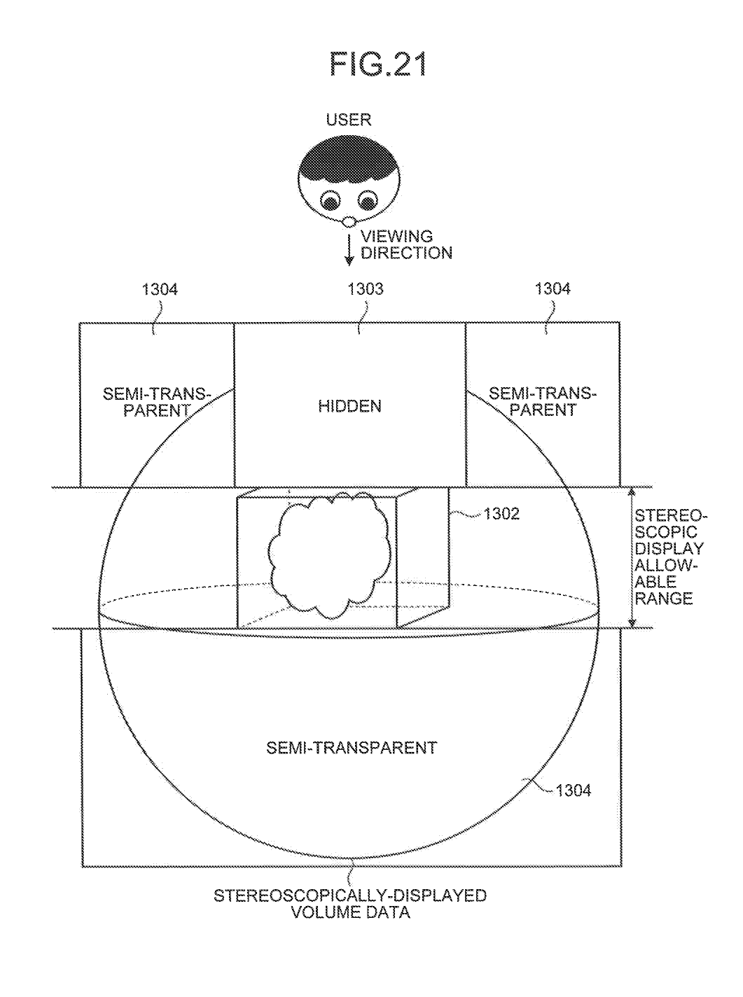

Still alternatively, as illustrated in FIG. 21, the image generator 43 can generate a stereoscopic image of the volume data in such a way that, of the volume data, an overlapping image portion 1303 which overlaps with an region of interest 1302 and which is positioned on the outside of the stereoscopic display allowable range during the stereoscopic display is hidden, and an image portion 1304 which is the image portion other than the overlapping image portion 1303 and which is stereoscopically displayed on the outside of the stereoscopic display allowable range is closer to being transparent than the image portion (1302) which is stereoscopically displayed within the stereoscopic display allowable range. Moreover, for example, regarding the image portion that is stereoscopically displayed around the boundary between the inside of the stereoscopic display allowable range and the outside of the stereoscopic display allowable range, it is possible to set a gradation by varying in a stepwise manner the values of transmittance indicating the rate of permeability of light. For example, regarding the image portion that is stereoscopically displayed around the boundary between the inside of the stereoscopic display allowable range and the outside of the stereoscopic display allowable range, the image generator 43 can generate a stereoscopic image of the volume data in such a way that the image portion increasingly becomes closer to being transparent along with an increase in the distance from the stereoscopic display allowable range.

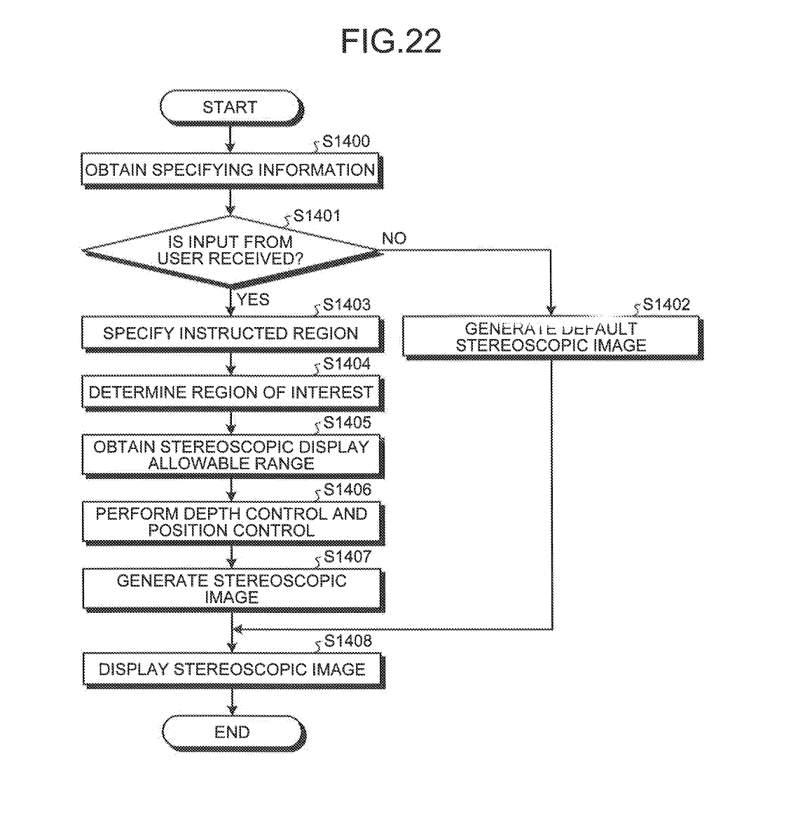

Explained below with reference to FIG. 22 is an example of operations performed in the stereoscopic image display device 30 according to the embodiment. FIG. 22 is a flowchart for explaining an example of operations performed in the stereoscopic image display device 30. Firstly, the obtainer 44 obtains the specifying information that is stored in the image archiving device 20 (Step S1400). Then, the specifier 47 determines whether or not the receiver 46 has received an input from a user (Step S1401). If it is determined that no input is received from a user (NO at Step S1401), then the specifier 47 does not specify the instructed region and notifies the image generator 43 that no input is received from a user. In that case, the image generator 43 obtains the volume data and the specifying information stored in the image archiving device 20, and generates a default stereoscopic image (Step S1402). Then, the image generator 43 sends the default stereoscopic image to the display 50, and the display 50 displays the default stereoscopic image received from the image generator 43 (Step S1408).

Meanwhile, at Step S1401, if it is determined that an input is received from a user (YES at Step S1401), then the specifier 47 specifies the instructed region according to the input from the user (Step S1403). Subsequently, the determiner 48 determines the region of interest by using the specifying information and the instructed region (Step S1404). Moreover, the controller 42 obtains the stereoscopic display allowable range (Step S1405). For example, the controller 42 can access a memory (not illustrated) and obtain the stereoscopic display allowable range that has been set in advance. Then, the controller 42 performs the depth control and the position control using the stereoscopic display allowable range and the region of interest (Step S1406). Subsequently, according to the result of the control performed by the controller 42, the image generator 43 generates a stereoscopic image of the volume data (Step S1407). Then, the image generator 43 sends the stereoscopic image of the volume data to the display 50, and the display 50 displays the stereoscopic image of the volume data received from the image generator 43 (Step S1408). These operations are performed in a repeated manner at predetermined intervals.

As described above, in the embodiment, when an region of interest, on which the user should focus, is set in the volume data; the controller 42 performs at least either the depth control, in which the depth range of the region of interest that is stereoscopically displayed on the display 50 is set to a value closer to the stereoscopic display allowable range as compared to the state prior to setting the region of interest, or the position control, in which the display position of the region of interest is set close to the display surface. As a result, it becomes possible to enhance the visibility of the stereoscopic image of the region of interest.

### (1) First Modification Example

FIG. 23 is a block diagram illustrating an image processor 400 according to a modification example. As compared to the embodiment described above, the image processor 400 differs in the way that an adjustor 70 is additionally included. The adjustor 70 adjusts a range of the region of interest according to an amount of slide of a slide bar which is displayed on the screen of the display 50 is operated by the user. Herein, the constituent elements identical to the constituent elements according to the embodiment described above are referred to by the same reference numerals, and the explanation of such constituent elements is not repeated.

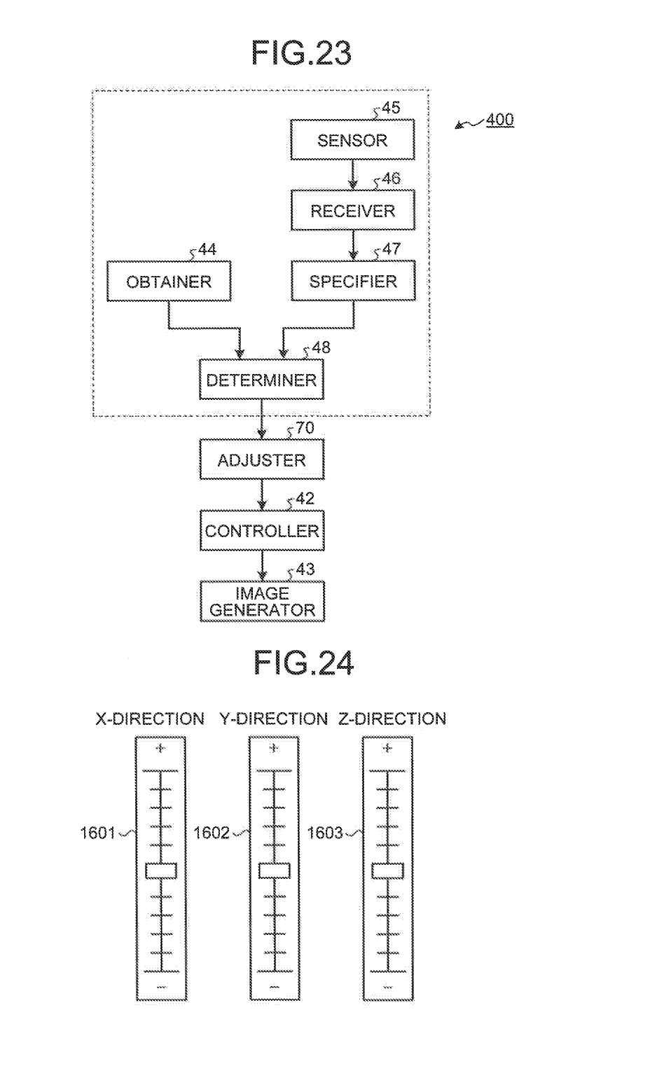

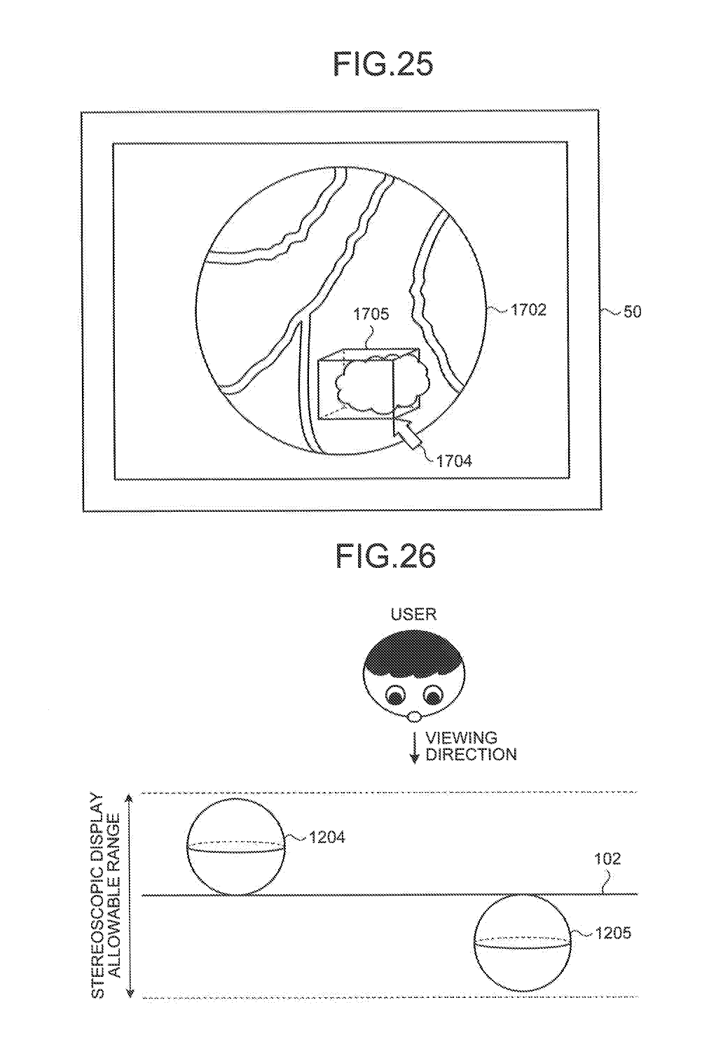

The adjuster 70 adjusts the range of the region of interest, which is set by the setter 41, according to the input from the user. For example, as illustrated in FIG. 24, the configuration can be such that a slide bar for the X-direction, a slide bar for the Y-direction, and a slide bar for the Z-direction are displayed on the screen of the display 50; and the adjuster 70 adjusts the range of the region of interest according to the amount of slide in each slide bar. In the example illustrated in FIG. 24, for example, if a slide bar 1601 is moved in the “+(plus)” direction, then there is an increase in the size of the region of interest in the X-direction. However, if the slide bar 1601 is moved in the “− (minus)” direction, then there is a decrease in the size of the region of interest in the X-direction. Alternatively, for example, as illustrated in FIG. 25, the configuration can be such that volume data (a medical image) 1702 that is displayed on the display 50 has an region of interest 1705 displayed thereon as preview; and, if an operation for moving an apex of the region of interest 1705 is performed using a mouse cursor 1704, then the adjuster 70 adjusts the range of the region of interest 1705 according to the operation input.

### (2) Second Modification Example

For example, according to the depth range of the region of interest, the controller 42 can control the size of the region of interest to be displayed in a plane perpendicular to the depth direction. As an example of this control method, when a standard value of the depth range (i.e., the depth range before performing the depth control) is set to “1” and when, as a result of performing the depth control, the depth range is set to “1.4”; it is possible to think of a method in which the enlargement factor in the X-direction and in the Y-direction of the region of interest is set to “1.4”. As a result, the depth range of the region of interest that is stereoscopically displayed on the display 50 is enlarged by 1.4 times, and the size of the region of interest that is displayed in a plane perpendicular to the depth direction is also enlarged by 1.4 times from the standard size.

The image generator 43 generates a stereoscopic image of the volume data according to the depth range set by the controller 42 and according to the enlargement factor in the X-direction and in the Y-direction. Depending on the enlargement factor in the X-direction and in the Y-direction, it is possible to think of a case when the region of interest does not fit within the display surface. In such a case, either a stereoscopic image can be generated only for that portion of the region of interest which fits within the display surface, or a stereoscopic image for the portion not fitting within the display surface can also be generated at the same time. Besides, the stereoscopic image can be generated by matching the enlargement factor in the X-direction and the Y-direction of the volume data other than the region of interest to the enlargement factor of the region of interest.

### (3) Third Modification Example

For example, as illustrated in FIG. 26, within the stereoscopic display allowable range, the controller 42 can set the display position of an region of interest 1204 on the near side (the observation side) as compared to the display surface 102, or can set the display position of an region of interest 1205 on the far side as compared to the display surface 102.

### (4) Fourth Modification Example

In the embodiment described above, the medical diagnostic imaging device 10 analyzes the volume data generated therein and generates the specifying information. However, that is not the only possible case. Alternatively, for example, the stereoscopic image display device 30 can be configured to analyze the volume data. In that case, for example, the medical diagnostic imaging device 10 sends only the generated volume data to the image archiving device 20, and the stereoscopic image display device 30 obtains the volume data stored in the image archiving device 20. Meanwhile, for example, instead of using the image archiving device 20, a memory for storing the generated volume data can be disposed in the medical diagnostic imaging device 10. In this case, the stereoscopic image display device 30 obtains the volume data from the medical diagnostic imaging device 10.

Then, the stereoscopic image display device 30 analyzes the obtained volume data and generates the specifying information. Herein, the specifying information generated by the stereoscopic image display device 30 either can be stored in a memory in the stereoscopic image display device 30 along with the volume data obtained from the medical diagnostic imaging device 10 or obtained from the image archiving device 20; or can be stored in the image archiving device 20.

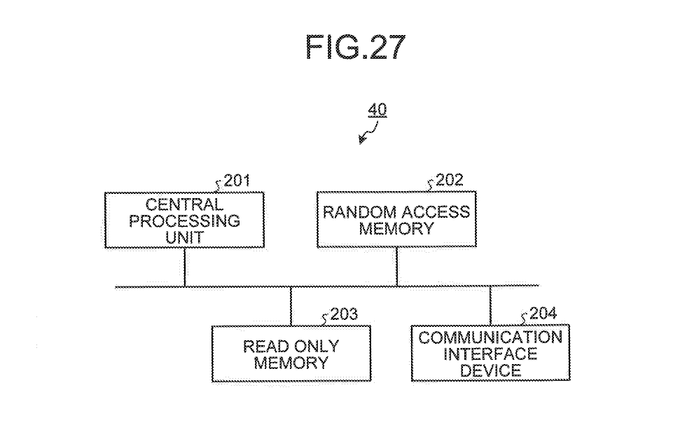

As illustrated in FIG. 27, The image processor 40 according to the embodiment described above has a hardware configuration including a central processing unit (CPU) 201, a read only memory (ROM) 203, a random access memory (RAM) 202, and a communication interface (I/F) device 204. Each of the functions described above is implemented when the CPU 201 loads a computer program from the ROM 203 in the RAM 202 and executes the computer program. However, that is not the only possible case. Alternatively, at least some of the functions can be implemented using individual circuits (i.e., using hardware).

The computer program, which is executed in the image processor 40 according to the embodiment described above, can be stored in a downloadable manner in a computer connected to a network such as the Internet or can be made available for distribution through a network such as the Internet. Alternatively, the computer program, which is executed in the image processor 40 according to the embodiment described above, can be stored in advance in a ROM or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
an obtainer that obtains a position of an object to be observed in volume data of a medical image;
a determiner that determines a region of interest by using the position of the object and an instructed region inputted by a user in the volume data so that the region of interest includes at least part of the object;
a controller that controls a relation between the region of interest and a display range that indicates a range allowed to be displayed stereoscopically on a display; and
a generator that generates a stereoscopic image of the volume data according to the relation between the region of interest and the display range.

2. The device according to claim 1, wherein the controller controls the relation between the region of interest and the display range so that the region of interest is included in the display range.

3. The device according to claim 1, wherein
the display range includes a display surface,
the controller controls the relation between the region of interest and the display range so that a display position of the region of interest is close to the display surface, and
the generator generates the stereoscopic image of which a pixel on the display surface neither pops out nor recedes.

4. The device according to claim 1, wherein the generator generates the stereoscopic image of the volume data in such a way that, of the volume data, a region which overlaps with the region of interest is hidden.

5. The device according to claim 1, wherein the generator generates the stereoscopic image of the volume data in such a way that, of the volume data, a region which does not overlap with the region of interest and which is positioned on the outside of the display range is translucent.

6. The device according to claim 1, further comprising an adjustor that adjusts a range of the region of interest according to an amount of slide of a slide bar which is operated by the user.

7. The device according to claim 3, wherein the controller sets the display position of the region of interest on a near side as compared to the display surface.

8. The device according to claim 2, wherein the controller performs control to bring a depth of the region of interest closer to an upper limit of the display range.

9. The device according to claim 1, wherein, when the object is present on periphery of the instructed area, the determiner determines, as the region of interest, an expanded area which includes the instructed region and at least some portion of the object present on the periphery of the instructed region.

10. The device according to claim 2, further comprising:
a sensor to detect a three-dimensional coordinate value of an input device that is used for the input from the user; and
a specifier that makes use of the three-dimensional coordinate value detected by the sensor and specifies a three-dimensional coordinate value in the volume data.

11. The device according to claim 1, wherein, according to a depth range of the region of interest, the controller controls a size of the region of interest displayed in a plane perpendicular to the depth direction.

12. The device according to claim 1, further comprising an adjuster that, according to an input from an user, adjusts a range of the region of interest.

13. The device according to claim 1, wherein the controller performs depth control in such a way that a ratio of a depth direction of the region of interest, which is displayed in a stereoscopic manner, and a direction perpendicular to the depth direction is close to a ratio in the real world.

14. A stereoscopic image display device comprising:
the device according to claim 1, and
the display.

15. The device according to claim 14, further comprising an input apparatus that includes:
an indicator that is used by the user to indicate a three-dimensional position; and
a sensor that detects a position of the indicator.

16. The device according to claim 15, wherein
the indicator emits infrared light or sound wave, and
the sensor detects the infrared light or the sound wave emitted from the indicator and detects the position of the indicator based on a period of time taken by the infrared light or the sound wave to reach the sensor.

17. An image processing device, comprising:
a processor; and
a memory that stores processor-executable instructions that, when executed by the processor, cause the processor to execute:
obtaining a position of an object to be observed in volume data of a medical image;
determining a region of interest by using the position of the object and an instructed region inputted by a user in the volume data so that the region of interest includes at least part of the object;
controlling a relation between the region of interest and a displayed range that indicates a range allowed to be displayed stereoscopically on a display; and
generating a stereoscopic image of the volume data according to the relation between the region of interest and the displayed range.

18. An image processing method comprising:
obtaining a position of an object to be observed in volume data of a medical image;
determining a region of interest by using the position of the object and an instructed region inputted by a user in the volume data so that the region of interest includes at least part of the object;
controlling a relation between the region of interest and a displayed range that indicates a range allowed to be displayed stereoscopically on a display; and
generating a stereoscopic image of the volume data according to the relation between the region of interest and the displayed range.
